(19) United States
(12) Patent Application Publication
(10) Pub. No.: US 2026/0149064 A1
(43) Pub. Date: May 28, 2026

(54) BATTERY MANAGEMENT APPARATUS, BATTERY MANAGEMENT METHOD, AND NON-TRANSITORY COMPUTER-READABLE MEDIUM

(71) Applicant: TOYOTA JIDOSHA KABUSHIKI KAISHA, Toyota-shi (JP)

(72) Inventors: Yoshiaki KIKUCHI, Toyota-shi (JP); Ryo MANO, Nisshin-shi (JP); Hiroki TASHIRO, Nisshin-shi (JP); Yuji NISHI, Nagoya-shi (JP); Keisuke ISHIKAWA, Nagakute-shi (JP)

(73) Assignee: TOYOTA JIDOSHA KABUSHIKI KAISHA, Toyota-shi (JP)

(21) Appl. No.: 19/330,091

(22) Filed: Sep. 16, 2025

(30) Foreign Application Priority Data
Oct. 2, 2024 (JP) 2024-172995

(51) Int. Cl. H01M 10/42; H01M 10/0525

(52) U.S. Cl. CPC H01M 10/425; H01M 10/0525; H01M 2010/4271

(57) ABSTRACT

A battery management apparatus, a battery management method, and a program capable of detecting an abnormality in a circuit that monitors the battery voltage of a lithium-ion secondary battery are provided. A battery management apparatus includes a first measurement circuit configured to measure a battery voltage of a lithium-ion secondary battery, a second measurement circuit configured to apply a high-frequency signal of 0.1 MHz or higher to the lithium-ion secondary battery and measure an amplitude of a resonating electric signal, and an abnormality detection unit configured to calculate the battery voltage of the lithium-ion secondary battery from the amplitude of the electric signal and detect an abnormality in the first measurement circuit based on the calculated battery voltage.

### CROSS REFERENCE TO RELATED APPLICATIONS

This application is based upon and claims the benefit of priority from Japanese patent application No. 2024-172995, filed on Oct. 2, 2024, the disclosure of which is incorporated herein in its entirety by reference.

### BACKGROUND

The present disclosure relates to a battery management apparatus, a battery management method, and a program.

It has been desired to suppress the increase of Li (lithium) deposited in a lithium-ion secondary battery in order to prevent the performance of the lithium-ion secondary battery from deteriorating. Patent Literature 1 discloses a technology for detecting the deposition of Li inside a lithium-ion secondary battery by applying a high-frequency signal to the lithium-ion secondary battery.
Patent Literature 1: Japanese Unexamined Patent Application Publication No. 2022-108602

### SUMMARY

It may be possible to use a technology for applying a high-frequency signal to a lithium-ion secondary battery and measuring the amplitude of a resonating electric signal for the detection of an abnormality in a circuit that monitors a battery voltage.

The present disclosure has been made to solve such a problem, and provides a battery management apparatus, a battery management method, and a program capable of detecting an abnormality in a circuit that monitors the battery voltage of a lithium-ion secondary battery.

A battery management apparatus according to the present disclosure includes: a first measurement circuit configured to measure a battery voltage of a lithium-ion secondary battery; a second measurement circuit configured to apply a high-frequency signal of 0.1 MHz or higher to the lithium-ion secondary battery and measure an amplitude of a resonating electric signal; and an abnormality detection unit configured to calculate the battery voltage of the lithium-ion secondary battery from the amplitude of the electric signal and detect an abnormality in the first measurement circuit based on the calculated battery voltage.

A battery management method according to the present disclosure includes: measuring a battery voltage of a lithium-ion secondary battery by using a first measurement circuit; applying a high-frequency signal of 0.1 MHz or higher to the lithium-ion secondary battery and measuring an amplitude of a resonating electric signal; and calculating the battery voltage of the lithium-ion secondary battery from the amplitude of the electric signal and detecting an abnormality in the first measurement circuit based on the calculated battery voltage.

A program according to the present disclosure is a program for a battery management apparatus, the battery management apparatus including: a first measurement circuit configured to measure a battery voltage of a lithium-ion secondary battery; and a second measurement circuit configured to apply a high-frequency signal of 0.1 MHz or higher to the lithium-ion secondary battery and measure an amplitude of a resonating electric signal, in which the program is configured to cause the battery management apparatus to perform a process for calculating the battery voltage of the lithium-ion secondary battery from the amplitude of the electric signal, and detecting an abnormality in the first measurement circuit based on the calculated battery voltage.

According to the present disclosure, it is possible to provide a battery management apparatus, a battery management method, and a program capable of detecting an abnormality in a circuit that monitors the battery voltage of a lithium-ion secondary battery.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing an example of a battery management apparatus according to a first embodiment;

FIG. 2 is a circuit diagram showing an example of a second measurement circuit according to the first embodiment;

FIG. 3 is a graph for explaining an operation performed by the second measurement circuit according to the first embodiment;

FIG. 4 is a graph for explaining an example of changes in a damped oscillation waveform according to the first embodiment; and

FIG. 5 is a flowchart showing an example of operations performed by the battery management apparatus according to the first embodiment.

### DESCRIPTION OF EMBODIMENTS

Embodiments according to the present disclosure will be described hereinafter with reference to the drawings. However, the present disclosure is not limited to the embodiments described below. Further, the following description and drawings are simplified as appropriate in order to clarify the explanation.

### First Embodiment

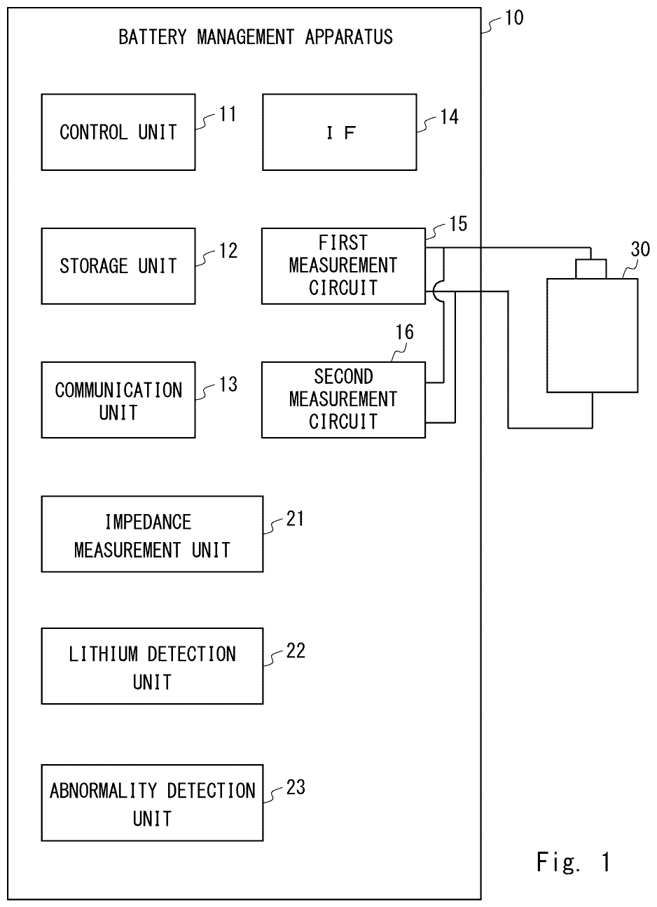

FIG. 1 is a block diagram showing an example of a battery management apparatus 10 according to a first embodiment. The battery management apparatus 10 manages the use of a manufactured lithium-ion secondary battery (cell 30). The cell 30 can be used, for example, for a driving system of a vehicle or a household energy supply system.

Firstly, the cell 30, for which the measurement is carried out, will be described. The cell 30 is formed as a lithium-ion secondary battery. The cell 30 may include, for example, a positive electrode, a negative electrode, and an ion-conducting medium which is interposed between the positive and negative electrodes and conducts carrier ions. The positive electrode may contain, as a positive electrode active material, a sulfide containing a transition metal element, an oxide containing lithium and a transition metal element, or the like. For the positive electrode active material, for example, a lithium-manganese composite oxide of which a basic compositional formula is expressed as Li₍₁₋ₓ₎MnO₂ (0<x<1 or the like, the same applies hereinafter), Li₍₁₋ₓ₎Mn₂O₄, or the like, a lithium-cobalt composite oxide of which a basic compositional formula is expressed as Li₍₁₋ₓ₎CoO₂ or the like, a lithium-nickel composite oxide of which a basic compositional formula is expressed as Li₍₁₋ₓ₎NiO₂ or the like, or a lithium-nickel-cobalt-manganese composite oxide of which a basic compositional formula is expressed as Li₍₁₋ₓ₎NiₐCo_{b}Mn_{c}O₂ (a+b+c=1) or the like can be used. Note that the term “basic compositional formula” means that other elements may be contained. The negative electrode may contain, as a negative electrode active material, a carbon material, a composite oxide containing lithium, or the like. Examples of negative electrode active materials include inorganic compounds such as lithium, lithium alloys, and tin compounds, carbon materials capable of absorbing and releasing lithium ions, composite oxides containing a plurality of elements, and conductive polymers. Examples of carbon materials include cokes, glassy carbon, graphite, non-graphitizable carbon, pyrolytic carbon, and carbon fibers. Among them, graphite such as artificial graphite and natural graphite is preferred. Examples of composite oxides include lithium-titanium composite oxides and lithium-vanadium composite oxides. The ion-conducting medium can be, for example, an electrolyte in which a supporting salt is dissolved. Examples of supporting salts include lithium salts such as LiPF₆ and LiBF₄. Examples of solvents for electrolytes include carbonates, esters, ethers, nitriles, furans, sulfolanes, and dioxolanes. Further, only one of them may be used, or two of more of them can be used in a mixed manner. Specifically, examples of carbonates include: cyclic carbonates such as ethylene carbonate, propylene carbonate, vinylene carbonate, butylene carbonate, and chloroethylene carbonate; and chain carbonates such as dimethyl carbonate, ethylmethyl carbonate, diethyl carbonate, ethyl-n-butyl carbonate, methyl-t-butyl carbonate, di-i-propyl carbonate, and t-butyl-1-propyl carbonate. Further, for the ion-conducting medium, a solid ion-conducting polymer, a mixed material of an inorganic solid electrolyte or an organic polymer electrolyte and an inorganic solid electrolyte, an inorganic solid powder bound by an organic binder, or the like can be used. For the solid electrolyte or the cell 30, a separator may be disposed between the positive and negative electrodes.

The battery management apparatus 10 includes, as a main hardware configuration, a control unit 11, a storage unit 12, a communication unit 13, an interface unit 14 (IF; Interface), a first measurement circuit 15, and a second measurement circuit 16. The control unit 11, the storage unit 12, the communication unit 13, the interface unit 14, the first measurement circuit 15, and the second measurement circuit 16 are connected to each other through a data bus and the like.

The control unit 11 is, for example, a processor such as a CPU (Central Processing Unit). The control unit 11 has a function as an arithmetic apparatus that performs control processing and arithmetic processing. Note that the control unit 11 may include a plurality of processors. The control unit 11 may include a processor mounted on a substrate on which the second measurement circuit 16 is mounted.

The storage unit 12 is, for example, a storage device such as a memory or a hard disk drive. The storage unit 12 is, for example, a ROM (Read Only Memory) or a RAM (Random Access Memory). The storage unit 12 has a function for storing, for example, a control program and an arithmetic program executed by the control unit 11. The memory stores one or more instructions. Further, the storage unit 12 also has a function for temporarily storing processing data. The storage unit 12 may include a database. Further, the storage unit 12 may include a plurality of memories.

The communication unit 13 is an interface for communicating with other apparatuses through a network. The interface unit 14 is, for example, a user interface (UI). The interface unit 14 includes an output device such as a display or a speaker. The interface unit 14 may also include an input device such as a keyboard, a touch panel, or a mouse. The interface unit 14 may be configured so that an input device and an output device are integrated with each other, such as being formed as a touch screen (touch panel).

The first measurement circuit 15 measures the battery voltage of the cell 30. The first measurement circuit 15 may be any circuit or the like capable of measuring the voltage of the cell 30. The specific configuration of the first measurement circuit 15 is well known.

The second measurement circuit 16 includes a resonant circuit for applying a high-frequency signal of 0.1 MHz or higher to the cell 30. The frequency of the high-frequency signal may be 0.5 MHz or higher. The resonant circuit may be, for example, an LCR resonant circuit. By applying a high-frequency signal to the cell 30, a damped oscillation waveform in which the amplitude of the resonating electric signal gradually decays is obtained. The second measurement circuit 16 measures the amplitude of the resonating electric signal. The damping rate (or decaying rate) of the damped oscillation waveform is obtained from amplitude values obtained at two different times, and the deposition of Li in the cell 30 is detected based on the damping rate. The measured amplitude is also used to detect an abnormality in the first measurement circuit 15.

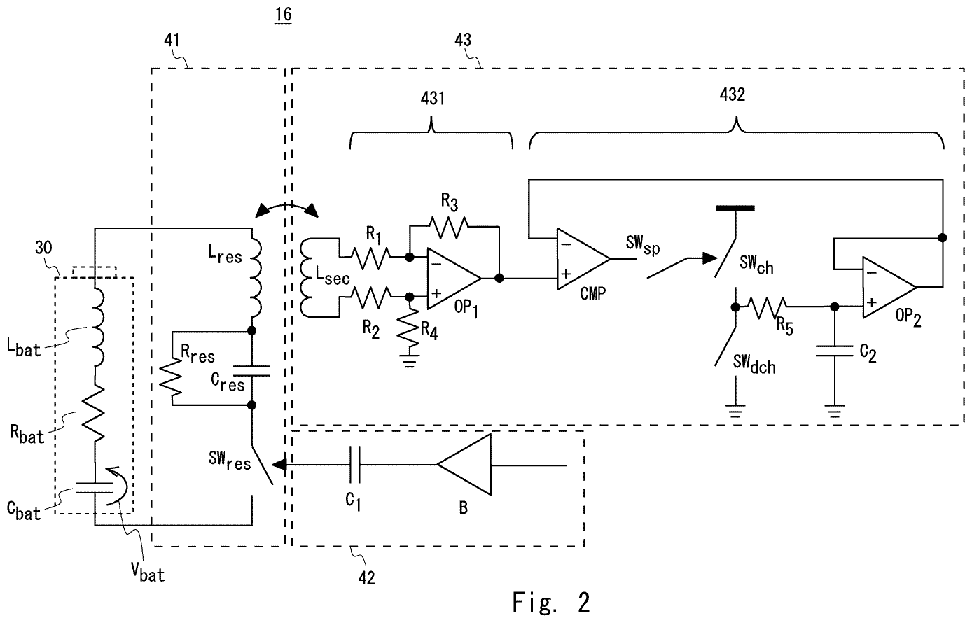

FIG. 2 is a circuit diagram showing an example of the second measurement circuit 16. The second measurement circuit 16 includes a resonant circuit 41, a sensor buffer circuit 42, and an amplitude measurement circuit 43. Note that the circuit configuration of the second measurement circuit 16 is not limited to that shown in FIG. 2. For example, a peak holding circuit 432 of the second measurement circuit 16 may be a peak holding circuit including a diode. Alternatively, the second measurement circuit 16 may be a circuit that acquires the waveform of a dumped oscillation current flowing through the resonant circuit 41 by using a high-speed AD converter.

The cell 30, for which the measurement is carried out, is represented by an equivalent circuit in which an inductance L_{bat}, a resistance R_{bat}, and a capacitance C_{bat} are connected to one another in series. The voltage applied across both ends of the capacitance C_{bat} corresponds to the battery voltage V_{bat}. The inductance L_{bat} represents the parasitic inductance in the cell 30. The resistance R_{bat} corresponds to the real part of the impedance of the cell 30. The capacitance C_{bat} represents the parasitic capacitance in the cell 30.

The resonant circuit 41 includes an inductance Lᵣₑₛ, a capacitance Cᵣₑₛ, a resistance Rᵣₑₛ, and a switch SWᵣₑₛ. The inductance Lᵣₑₛ is also referred to as a resonant inductance. The inductance Lᵣₑₛ may be formed by a winding. The inductance Lᵣₑₛ is coupled to the inductance L_{sec} of the amplitude measurement circuit 43, and constitutes a transformer together with the inductance L_{sec}. The inductance L_{sec} may be also formed by a winding. The capacitance Cᵣₑₛ is also referred to as a resonant capacitance. The capacitance Cᵣₑₛ may be a capacitor which is a passive element. Alternatively, the capacitance Cᵣₑₛ may be a capacitive active element such as a varicap. The switch SWᵣₑₛ may be a semiconductor switch or a mechanical switch.

One end of the inductance Lᵣₑₛ is connected to the positive electrode of the cell 30, and the other end thereof is connected to one end of the capacitance Cᵣₑₛ. The other end of the capacitance Cᵣₑₛ is connected to one end of the switch SWᵣₑₛ, and the other end of the switch SWᵣₑₛ is connected to the negative electrode of the cell 30. A discharge resistance Rᵣₑₛ is connected to the capacitance Cᵣₑₛ in parallel thereto.

The sensor buffer circuit 42 outputs a control signal to the switch SWᵣₑₛ. The control signal may be generated by the control unit 11. The sensor buffer circuit 42 may drive the switch SWᵣₑₛ through a buffer B and a capacitance C₁. The control signal rises from a low level to a high level, remains at the high level for a predetermined time, and then falls from the high level to the low level. When the control signal is at the high level, the switch SWᵣₑₛ is turned on. The switch SWᵣₑₛ becomes continuity according to the control signal in a pulsed manner. Note that “becoming continuity in a pulsed manner” means a series of operations in which the switch SWᵣₑₛ changes from an Off-state to an On-state, is maintained in the On-state for a predetermined time, and then changes from the On-state to the Off-state.

As the switch SWᵣₑₛ becomes continuity in a pulsed manner, a pulse voltage, which is determined based on the output voltage of the cell 30, is applied from the positive electrode of the cell 30 to the resonant circuit 41. As a result, a dumped oscillation current which gradually decays while oscillating at the resonant frequency flows through the resonant circuit 41. The decay of the dumped oscillation current occurs due to losses caused by the discharge resistance Rᵣₑₛ and the resistance R_{bat}. An induced electromotive force having a damped oscillation waveform is generated in the inductance L_{sec} according to the dumped oscillation current flowing through the inductance Lᵣₑₛ.

The amplitude measurement circuit 43 includes an inductance L_{sec}, an amplification circuit 431, and a peak holding circuit 432. As described previously, the inductance L_{sec} is coupled to the inductance Lᵣₑₛ of the resonant circuit 41. The amplification circuit 431 amplifies the induced electromotive force generated in the inductance L_{sec}. The amplification circuit 431 may be, for example, a differential amplification circuit formed by an operational amplifier OP₁ and resistors R₁ to R₄.

The peak holding circuit 432 includes a comparator CMP, a switch SWₛₚ, a switch SW_{ch}, a switch SW_{dch}, a resistance R₅, a capacitance C₂, and an operational amplifier OP₂. The peak holding circuit 432 holds the peak value of the damped oscillation waveform amplified by the amplification circuit 431 in response to the input of a control signal for controlling On/Off of the switch SWₛₚ. The control signal may be generated by the control unit 11.

The comparator CMP compares the amplified induced electromotive force with a voltage fed back from the operational amplifier OP₂, and outputs a high level when the amplified induced electromotive force is larger, and outputs a low level in the other cases. One end of the switch SWₛₚ is connected to the output terminal of the comparator CMP, and the On/Off of the switch SW_{ch} is controlled according to the output from the other end of the switch SWₛₚ. When the output of the comparator CMP is a high level, the switch SW_{ch} is turned on. One end of the capacitance C₂ is connected to a power supply potential through the resistance R₅ and the switch SW_{ch}, and the other end of the capacitance C₂ is connected to a ground potential.

When or after the switch SWᵣₑₛ of the resonant circuit 41 is turned on, the switch SWₛₚ is turned on and then is turned off after a predetermined time has elapsed. Then, the capacitance C₂ is charged according to the result of the comparison by the comparator CMP. When the charge accumulated in the capacitance C₂ is to be discharged, the switch SW_{dch}, which is in the Off state, is turned on. The control signal of the switch SW_{dch} may also be generated by the control unit 11.

The operational amplifier OP₂ forms a voltage follower and feeds back the voltage applied to the capacitance C₂ to the negative input terminal of the comparator CMP. The operational amplifier OP₂ outputs the peak value of the damped oscillation waveform amplified by the amplification circuit 431. The amplitude measurement circuit 43 may also include an A/D converter for converting the analog signal output from the operational amplifier OP₂ into a digital signal.

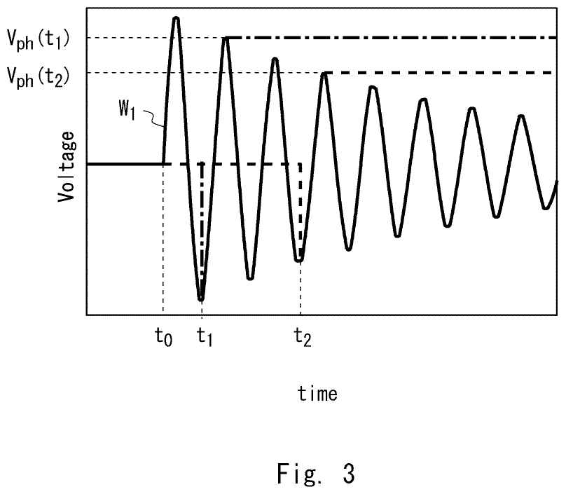

The operation performed by the second measurement circuit 16 will be described with reference to FIG. 3. The horizontal axis indicates the time, and the vertical axis indicates the voltage. A waveform W₁ represents the damped oscillation waveform amplified by the amplification circuit 431. A time t₀ represents a time at which the switch SWᵣₑₛ of the resonant circuit 41 is turned on. Times t₁ and t₂ represent times at each of which the switch SWₛₚ of the peak holding circuit 432 is turned on. A voltage Vₚₕ(t₁) represents the output voltage of the operational amplifier OP₂ when the switch SWₛₚ of the peak holding circuit 432 is turned on at the time t₁. A voltage Vₚₕ(t₂) represents the output voltage of the operational amplifier OP₂ when the switch SWₛₚ of the peak holding circuit 432 is turned on at the time t₂.

Note that, in practice, the voltages Vₚₕ(t₁) and Vₚₕ(t₂) are not held within one cycle of the damped oscillation waveform. That is, in practice, a process for turning on the switch SWᵣₑₛ and thereby generating a damped oscillation waveform at the time t₀, and a process for turning on the switch SWₛₚ and thereby starting peak holding at the time t₁ or t₂ are repeated one after another, and the output voltage of the operational amplifier OP₂ gradually follows the voltage Vₚₕ(t₁) or Vₚₕ(t₂).

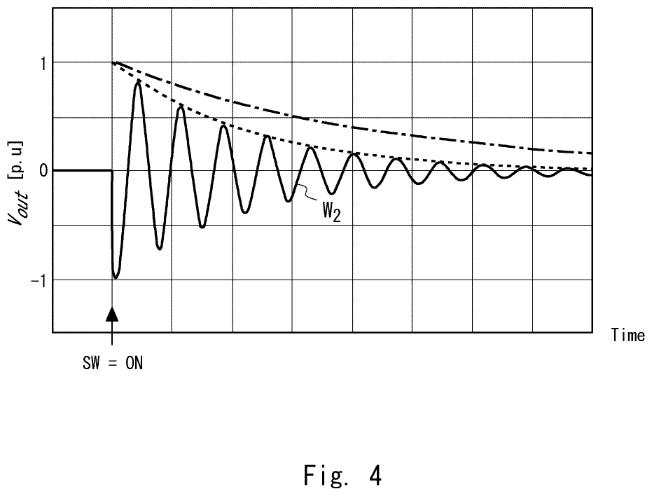

A waveform W2 shown in FIG. 4 represents a damped oscillation waveform that is generated when a high-frequency signal is applied to the cell 30 in the initial state. A vertical arrow indicates a time at which the switch SWᵣₑₛ is turned on. The envelope of the waveform W2 is indicated by a dotted line. When Li is deposited in the cell 30, for example, a damped oscillation waveform whose envelope is a curved line indicated by a dashed line is obtained. Therefore, it is possible to determine whether or not Li has been deposited based on the damping rate of the damped oscillation waveform.

Referring to FIG. 1 again, the battery management apparatus 10 includes, as its functions, an impedance measurement unit 21, a lithium detection unit 22, and an abnormality detection unit 23. These functions can be implemented, for example, by executing a program under the control of the control unit 11. More specifically, each function can be implemented by having the control unit 11 execute a program (instructions) stored in the storage unit 12. Alternatively, each function can be implemented by hardware such as a circuit or a semiconductor chip.

The impedance measurement unit 21 measures the real part of the impedance of the cell 30 based on the damping rate of the amplitude of the electric signal measured by the second measurement circuit 16. For example, the impedance measurement unit 21 can calculate the real part R_{bat} of the impedance of the cell 30 based on the damping rate a of the amplitude of the electric signal by using Expression (10) (which will be described below).

Next, an example of a method for calculating the real part R_{bat} of the impedance of the cell 30 will be described with reference to mathematical expressions. The voltage Vᵣₑₛ(t) input to the positive input terminal of the comparator CMP shown in FIG. 2 is expressed by Expressions (1) to (6). Lₛ in Expression (1) is a combined inductance of the inductance Lᵣₑₛ and the inductance L_{bat}, connected in series, and is calculated by Expression (3). M in Expression (1) represents a mutual inductance between the inductance Lᵣₑₛ and the inductance L_{sec}. α in Expression (1) is the damping rate of the resonant signal. ω₀ in Expression (1) is the resonant angular frequency, and is calculated by Expression (5). Cₛ in Expression (5) is a combined capacitance of the capacitance Cᵣₑₛ and the capacitance C_{bat} connected in series, and is calculated by Expression (2). β in Expression 1 is a phase difference of the resonant signal and is expressed by Expression (6).

$$[ Expression 1 ]$$

$${V}_{r e s} ( t ) = \frac{M {V}_{bat}}{{L}_{s}} \sqrt{\frac{{α}^{2}}{{ω}_{0}^{2}} + 1} {e}^{- α t} cos ( {ω}_{0} t + β ) \qquad ( 1 )$$

$$[ Expression 2 ]$$

$${C}_{s} = \frac{{C}_{r e s} + {C}_{bat}}{{C}_{r e s} + {C}_{bat}} \approx {C}_{r e s} \qquad ( 2 )$$

$$[ Expression 3 ]$$

$${L}_{s} = {L}_{r e s} + {L}_{b a t} \approx {L}_{r e s} \qquad ( 3 )$$

$$[ Expression 4 ]$$

$$α = \frac{{R}_{bat}}{2 {L}_{s}} + \frac{1}{2 {C}_{res} {R}_{res}} \qquad ( 4 )$$

$$[ Expression 5 ]$$

$${ω}_{0} = \sqrt{\frac{{R}_{r e s} + {R}_{b a t}}{{R}_{res} {L}_{s} {C}_{s}} - {α}^{2}} \qquad ( 5 )$$

$$[ Expression 6 ]$$

$$β = arcsin ( \frac{{e}^{- α t} {L}_{S}}{\sqrt{\frac{{α}^{2}}{{ω}_{0}^{2}} + 1}} ) \qquad ( 6 )$$

The resonant voltage Vᵣₑₛ(tₙ) at an n-th resonant point is expressed by Expression (7). tₙ represents, for example, a time at which the damped oscillation waveform W1 shown in FIG. 3 has a peak value. Vᵣₑₛ(tₙ) corresponds to, for example, Vₚₕ(t₁) or Vₚₕ(t₂) in FIG. 3.

$$[ Expression 7 ]$$

$${V}_{r e s} ( {t}_{n} ) = \frac{M {V}_{b a t}}{{L}_{s}} \sqrt{\frac{{α}^{2}}{{ω}_{0}^{2}} + 1} {e}^{- α {t}_{n}} \qquad ( 7 )$$

For arbitrary n=n1 and n=n2 (n1>n2), the damping rate a is calculated by Expression (8).

$$[ Expression 8 ]$$

$$α = \frac{1}{{t}_{n 2} - {t}_{n 1}} ln \frac{\vert {V}_{r e s} ( {t}_{n 1} ) \vert}{\vert {V}_{r e s} ( {t}_{n 2} ) \vert} \qquad ( 8 )$$

When Rᵣₑₛ>>R_{bat}, ω₀ is expressed by Expression (9).

$$[ Expression 9 ]$$

$${ω}_{0} = \sqrt{\frac{1}{{L}_{s} {C}_{s}} - {α}^{2}} \qquad ( 9 )$$

R_{bat} represents the real part of the impedance of the lithium-ion secondary battery as described above. Further, since the capacitance C_{bat} of the cell 30 is very small, the imaginary part of the impedance is represented by L_{bat}. Based on the above-shown Expressions (3) and (4), Expression (10) holds (i.e., is obtained). Further, based on the above-shown Expressions (3) and (9), Expression (11) holds (i.e., is obtained).

$$[ Expression 10 ]$$

$${R}_{bat} = 2 ( {L}_{r e s} + {L}_{b a t} ) \{ α - \frac{1}{2 {C}_{r e s} {R}_{r e s}} \} \qquad ( 10 )$$

$$[ Expression 11 ]$$

$${L}_{bat} = \frac{1}{{C}_{s}} \frac{1}{{ω}_{0}^{2} + {α}^{2}} - {L}_{res} \qquad ( 11 )$$

For example, L_{bat} is calculated from Expression (11) based on the damping rate a and resonant frequency ω₀ calculated by using the above-shown Equations (8) and (9). tₙ₂−tₙ₁ in Expression (8) may be approximated by t₂−t₁ shown in FIG. 3. Then, R_{bat} is calculated from Expression (10) based on L_{bat}.

Referring to FIG. 1 again, the lithium detection unit 22 of the battery management apparatus 10 detects that Li has been deposited in the cell 30 based on R_{bat} calculated by the impedance measurement unit 21. The lithium detection unit 22 may detect that Li has been deposited, for example, when R_{bat} is smaller than a reference value. The reference value may be determined based on the initial value or the like of R_{bat}, or based on manufacturing data or material data of the cell 30. When Li has been deposited in the cell 30, the control unit 11 may reduce the charging current or charging power of the cell 30.

The abnormality detection unit 23 calculates the battery voltage V_{bat} of the cell 30 from the amplitude of the resonating electric signal, and detects an abnormality in the first measurement circuit 15 based on the calculated battery voltage V_{bat}. That is, the abnormality detection unit 23 calculates the battery voltage of the cell 30 from the amplitude of the resonating electric signal through inverse calculation, and detects that an abnormality has occurred in the first measurement circuit 15 when the calculated battery voltage differs from the voltage measured by the first measurement circuit 15. In the case where the second measurement circuit 16 measures the amplitude of the electrical signal at two different times tₙ₁ and tₙ₂, the abnormality detection unit 23 may calculate the battery voltage from one of the measured amplitudes.

As shown in the above-shown Expression (7), M and Lₛ are obvious from information on the design of the second measurement circuit 16, and α is calculated from Expression (8) and do is calculated from Expression (9). Therefore, when tₙ is known, V_{bat} can be calculated from the amplitude Vᵣₑₛ(tₙ) of the resonant signal through inverse calculation. Note that tₙ can be calculated by using the above-shown Expression (6). For example, when Vᵣₑₛ(tₙ) in the above-shown Expression (1) has a maximum value, the phase is expressed as ω₀*tₙ+β=2π*n (n is an integer), and the relationship between β and tₙ is determined based on Expression (6), so that tₙ can be calculated. For example, from the above-described relationship in regard to the phase, candidates for tₙ may be obtained by numerical calculation or the like, and a candidate immediately after the time at which the peak holding is started (e.g., t₁ or t₂ in FIG. 3) may be defined as tₙ.

Note that the time tₙ at which the amplitude is maximized may be approximated by the time at which the peak holding is started (Example: t₁ or t₂). Alternatively, when the second measurement circuit 16 acquires a damped oscillation waveform, the abnormality detection unit 23 may determine tₙ based on the acquired waveform data.

When the difference between the battery voltage calculated from the amplitude of the resonating electric signal and the battery voltage measured by the first measurement circuit 15 exceeds a threshold, the abnormality detection unit 23 may detect that an abnormality has occurred in the first measurement circuit 15.

When an abnormality in the first measurement circuit 15 is detected, the abnormality detection unit 23 may output information indicating that an abnormality has occurred in the first measurement circuit 15 through the interface unit 14. Alternatively, the abnormality detection unit 23 may write, i.e., store, log data indicating that an abnormality has occurred in the first measurement circuit 15 in the storage unit 12. When an abnormality in the first measurement circuit 15 is detected, the battery management apparatus 10 may monitor the battery voltage of the cell 30 based on the battery voltage calculated by the abnormality detection unit 23.

The abnormality detection unit 23 may transmit information indicating that an abnormality has occurred in the first measurement circuit 15 to an external server or an external communication terminal through the communication unit 13. An operator may repair or replace the first measurement circuit 15 based on the information received by the server or the like.

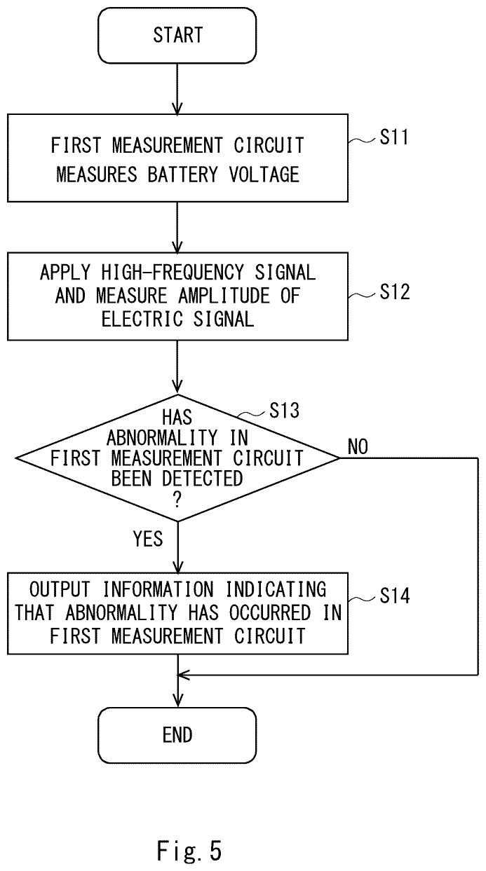

FIG. 5 is a flowchart showing an example of operations performed by the battery management apparatus 10. Firstly, the first measurement circuit 15 of the battery management apparatus 10 measures the battery voltage of the cell 30 (Step S11). Next, the second measurement circuit 16 of the battery management apparatus 10 applies a high-frequency current of 0.1 MHz or higher to the cell 30 and measures the amplitude of the resonating electric signal (Step S12). Next, the abnormality detection unit 23 of the battery management apparatus 10 calculates the battery voltage of the cell 30 from the amplitude of the resonating electric signal, and detects an abnormality in the first measurement circuit 15 based on the result of the calculation (Step S13). When an abnormality in the first measurement circuit 15 is detected (Yes in Step S13), the abnormality detection unit 23 outputs information indicating that an abnormality has occurred in the first measurement circuit 15 (Step S14). When no abnormality in the first measurement circuit 15 is detected (No in Step S13), or after the step S14, the battery management apparatus 10 finishes the series of processes.

The series of processes shown in FIG. 5 may be performed at regular intervals. Alternatively, the series of processes shown in FIG. 5 may be performed when the result of the measurement by the first measurement circuit 15 is abnormal. When the result of the measurement by the first measurement circuit 15 is abnormal, there may be a possibility that an abnormality has occurred in the cell 30 or in the first measurement circuit 15. The battery management apparatus 10 can determine whether the abnormality has occurred in the cell 30 or in the first measurement circuit 15 by performing the series of processes shown in FIG. 5. For example, an operator may repair or replace one of the cell 30 and the first measurement circuit 15 in which the abnormality has occurred by referring to the result of the detection by the abnormality detection unit 23.

In the first embodiment, it is possible to detect an abnormality in a circuit that measures the voltage of a lithium-ion secondary battery.

Although embodiments according to the present disclosure have been described above, the present disclosure includes arbitrary modifications in which the object and advantages of the present disclosure are not impaired, and is not limited by the above-described embodiments.

The first and second measurement circuits 15 and 16 do not have to be provided in each of all the cells, and instead may be provided only in a specific cell(s). Further, the first and second measurement circuits 15 and 16 may be provided in each battery module or each battery pack in which a plurality of cells are combined with one another.

In the aforementioned program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, the transitory computer readable media or communication media can include electrical, optical, acoustical, or other forms of propagation signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery management apparatus comprising:
a first measurement circuit configured to measure a battery voltage of a lithium-ion secondary battery;
a second measurement circuit configured to apply a high-frequency signal of 0.1 MHz or higher to the lithium-ion secondary battery and measure an amplitude of a resonating electric signal; and
an abnormality detection unit configured to calculate the battery voltage of the lithium-ion secondary battery from the amplitude of the electric signal and detect an abnormality in the first measurement circuit based on the calculated battery voltage.

2. The battery management apparatus according to claim 1, further comprising:
an impedance measurement unit configured to measure a real part of an impedance of the lithium-ion secondary battery based on a damping rate of the amplitude of the electric signal; and
a lithium detection unit configured to detect that Li has been deposited in the lithium-ion secondary battery based on the real part of the impedance.

3. The battery management apparatus according to claim 1, wherein the abnormality detection unit calculates the battery voltage of the lithium-ion secondary battery based on a resonant frequency of the electric signal, the damping rate of the amplitude of the electric signal, and a phase difference.

4. The battery management apparatus according to claim 1, wherein the first and second measurement circuits are provided for each battery cell of the lithium-ion secondary battery.

5. The battery management apparatus according to claim 1, wherein the second measurement circuit includes a resonant circuit configured to apply the high-frequency signal to the lithium-ion secondary battery and a peak holding circuit configured to measure the amplitude of the electrical signal.

6. A battery management method comprising:
measuring a battery voltage of a lithium-ion secondary battery by using a first measurement circuit;
applying a high-frequency signal of 0.1 MHz or higher to the lithium-ion secondary battery and measuring an amplitude of a resonating electric signal; and
calculating the battery voltage of the lithium-ion secondary battery from the amplitude of the electric signal and detecting an abnormality in the first measurement circuit based on the calculated battery voltage.

7. A non-transitory computer readable medium storing a program for a battery management apparatus,
the battery management apparatus comprising:
a first measurement circuit configured to measure a battery voltage of a lithium-ion secondary battery; and
a second measurement circuit configured to apply a high-frequency signal of 0.1 MHz or higher to the lithium-ion secondary battery and measure an amplitude of a resonating electric signal, wherein
the program is configured to cause the battery management apparatus to perform a process for calculating the battery voltage of the lithium-ion secondary battery from the amplitude of the electric signal, and detecting an abnormality in the first measurement circuit based on the calculated battery voltage.
